(19) United States
(12) Patent Application Publication
(10) Pub. No.: US 2026/0120133 A1
(43) Pub. Date: Apr. 30, 2026

(54) HYDROCARBON RECOVERY FROM A SUBSURFACE FORMATION

(71) Applicant: Landmark Graphics Corporation, Houston, TX (US)

(72) Inventors: Marc Paul Servais, Abingdon (GB); Graham Baines, Abingdon (GB); Lawrence Alexander Cowliff, Abingdon (GB)

(21) Appl. No.: 19/209,062

(22) Filed: May 15, 2025

Related U.S. Application Data
(60) Provisional application No. 63/714,725, filed on Oct. 31, 2024.

(51) Int. Cl. G06Q 30/0202; E21B 49/00; G06Q 50/02

(52) U.S. Cl. CPC G06Q 30/0202; E21B 49/00; G06Q 50/02; E21B 2200/20

(57) ABSTRACT

A method comprises obtaining well logs for at least one measurable subsurface formation attribute of a subsurface formation into which a wellbore is formed and performing a multi-stage operation to predict a pay probability for a zone in the subsurface formation that defines a likelihood that the zone includes hydrocarbons that are commercially viable for recovery. Performing the multi-stage operation comprises predicting, via at least one interpreted log machine-learning model using the well logs as inputs, interpreted logs of at least one interpreted subsurface attribute at corresponding depths of the wellbore; and predicting, via a pay zone probability machine-learning model using the interpreted logs as inputs, the pay probability for the zone.

### FIELD

Some implementations relate generally to the field of hydrocarbon recovery operations and more particularly to the field of determining hydrocarbon pay zone probabilities in a subsurface formation.

### BACKGROUND

In hydrocarbon recovery operations, a pay zone in hydrocarbon recovery may refer to the subsurface layer of rock or sediment that may contain commercially viable quantities of hydrocarbons (such as oil and/or natural gas). This zone may be characterized by sufficient porosity, shale volume (in conventional reservoirs), water and/or hydrocarbon saturation, etc., allowing hydrocarbons to accumulate and flow to production wells. The pay zone is typically identified through geological surveys and well logging, and its properties may be critical in determining the potential for extraction.

### BRIEF DESCRIPTION OF THE DRAWINGS

Implementation of the disclosure may be better understood by referencing the accompanying drawings.

FIGS. 1A-1B are schematics of exemplary well systems, according to some implementations.

FIG. 2 is a diagram of a two stage approach for generating pay zone probabilities, according to some implementations.

FIGS. 3A-3C are charts of pay zone probabilities with fuzzy cutoffs, according to some implementations.

FIG. 4 includes a chart of the probability density function approach for applying fuzzy cutoffs including uncertainty in the log estimate, according to some implementations.

FIGS. 5A-5B are charts depicting a pay probability estimator that takes interpreted logs as input, according to some implementations.

FIG. 6 is a flowchart of example operations for predicting pay zone probabilities at corresponding depths within a subsurface formation, according to some implementations.

FIG. 7 is a block diagram depicting an example computer, according to some implementations.

### DESCRIPTION

The description that follows includes example systems, methods, techniques, and program flows that embody aspects of the disclosure. However, it is understood that this disclosure may be practiced without these specific details. For instance, this disclosure refers to functions and/or learning machines for determining the pay zone probability. Aspects of this disclosure can also be applied to any other suitable function and/or learning machine to determine the pay zone probabilities. For clarity, some well-known instruction instances, protocols, structures, and techniques have been omitted.

Example implementations relate to estimating the pay zone probabilities at depths in a subsurface formation. Predicting pay zones (i.e. the extent to which a depth interval of reservoir contains economically recoverable hydrocarbons) within a well using wireline logs may be difficult to do in an understandable, tunable, and probabilistic way. It may be possible to train a machine learning model or to define a set of rules to predict pay zones, but such an approach may be difficult for the user to interrogate and understand. In some implementations, a two-stage process may be utilized to generate pay zone probabilities that may be more flexible, allow the user to have confidence in the methodology and tune it according to their requirements.

Given one or more wellbore formed in a subsurface formation with primary well logs, a two-stage workflow may be utilized for predicting pay in an understandable, tunable and probabilistic way. In the first stage, an interpreted log learning machine may predict interpreted logs based on the primary well logs. The primary well logs (such as gamma ray, density, neutron porosity, etc.) may be input into the interpreted log learning machine to generate interpreted logs as a function of depth. The interpreted logs may include VSHALE (volume of shale), PHIE (effective porosity) and SWE (effective water saturation), etc. In addition to the interpreted logs, the interpreted log learning machine may output the uncertainty associated with each interpreted log. The interpreted learning machine may include models such as random forests, extreme gradient boosting (XGBoost), histogram-based gradient boosting regression tree, etc.

In the second stage, the interpreted logs (and in some implementations, the associated uncertainties) may be provided as inputs to a pay probability estimator that generates a pay zone probability at corresponding depths. The pay probability estimator may be a function and/or machine learning model. If a function is used, it may be user-specified if required. The function (i.e., a pay zone function) may include binary cut-offs, fuzzy cutoffs, etc. In some implementations, the pay zone function may incorporate the uncertainty associated with each interpreted log and/or covariance. Alternatively, a pre-trained and/or custom machine learning model (i.e., a pay zone learning machine) may be used to generate the pay zone probability at the corresponding depths. In some implementations, the pay zone learning machine may predict oil pay zone probabilities and gas pay zone probabilities, separately.

In some implementations, a wellbore operation may be modified or updated based on the pay zone probabilities. For example, an operation (at the surface or downhole) may be performed and/or directed to be performed to change a wellbore operation based the pay zone probabilities at the corresponding depths. Examples of such wellbore operations may include selecting a drilling location of a wellbore, modifying perforating and/or hydraulic fracturing operations, selecting and/or positioning one or more artificial lift tools in the wellbore, modifying one or more wellbore attributes (such as choke setting), etc. For instance, a drilling location for a wellbore may be selected based, at least in part, on the pay zone probabilities of the offset wellbores. Alternatively, or in addition to, the depth of the producing interval (perforations, sand screen, open bore, etc.) of a wellbore drilled in a subsurface formation may be positioned based on the pay zone probabilities of the wellbore and/or offset wellbore(s).

### Example Systems

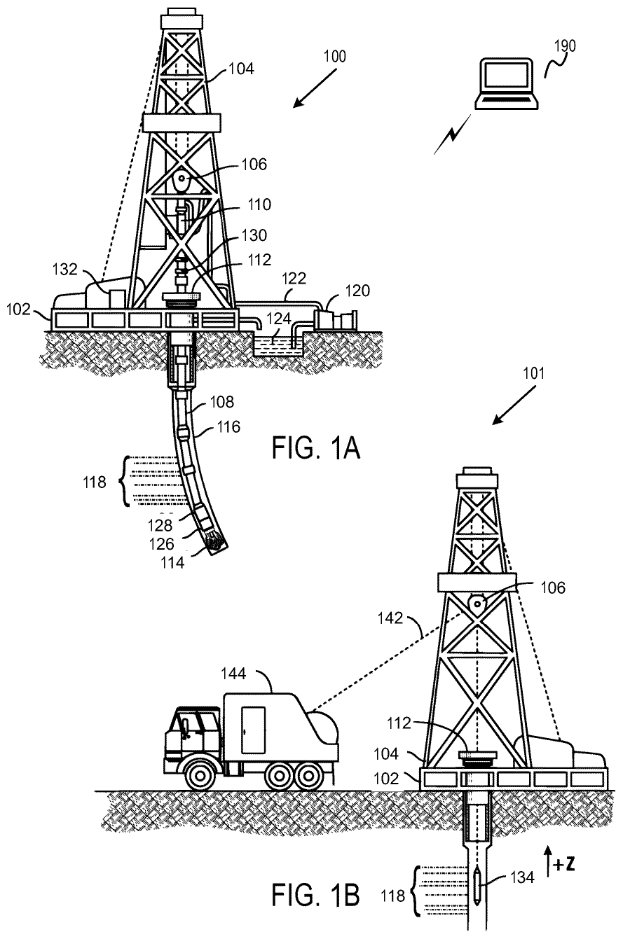

FIGS. 1A-1B are schematics of exemplary well systems, according to some implementations. FIG. 1A depicts an example drilling system 100. A drilling platform 102 supports a derrick 104 having a traveling block 106 for raising and lowering a drill string 108. A kelly 110 supports the drill string 108 as it is lowered through a rotary table 112. A drill bit 114 is driven by a downhole motor and/or rotation of the drill string 108. As the drill bit 114 rotates, it creates a wellbore 116 that passes through various subsurface formations 118. A pump 120 circulates drilling fluid through a feed pipe 122 to the kelly 110, downhole through the interior of the drill string 108, through orifices in the drill bit 114, back to the surface via the annulus around the drill string 108, and into a retention pit 124. The drilling fluid transports cuttings from the borehole into the retention pit 124 and aids in maintaining the borehole integrity.

A downhole tool 126 can be integrated into the bottom-hole assembly near the drill bit 114. The downhole tool 126 may comprise any of a number of different types of tools including measurement while drilling (MWD) tools, logging while drilling (LWD) tools, mud motors, and others. In some implementations, the downhole tool 126 may obtain logging data of the surrounding various subsurface formations 118 such as gamma ray, density, neutron porosity, etc.

For purposes of communication, a downhole telemetry sub 128 can be included in the bottom-hole assembly to transfer measurement data to a surface receiver 130 and to receive commands from the surface. Mud pulse telemetry is one common telemetry technique for transferring tool measurements to surface receivers and receiving commands from the surface, but other telemetry techniques can also be used. In some implementations, the downhole telemetry sub 128 can store logging data for later retrieval at the surface when the logging assembly is recovered.

At the surface, the surface receiver 130 can receive the uplink signal from the downhole telemetry sub 128 and can communicate the signal to a data acquisition module 132. The data acquisition module 132 can include one or more processors, storage mediums, input devices, output devices, software, etc. The data acquisition module 132 can collect, store, and/or process the data received from the bottom hole assembly.

At various times during the drilling process, the drill string 108 may be removed from the wellbore 116 as shown in FIG. 1B. FIG. 1B depicts an example wireline system 101 with a wireline tool 134 positioned in the wellbore 116 after the drill string 108 is removed.

Once the drill string has been removed, logging operations can be conducted using a wireline tool 134 (i.e., a sensing instrument sonde suspended by a cable 142 having conductors for transporting power to the tool and telemetry from the tool to the surface). The wireline tool 134 may have pads and/or centralizing springs to maintain the tool near the central axis of the borehole or to bias the tool towards the borehole wall as the tool is moved downhole or uphole. The wireline tool 134 can also include one or more navigational packages for determining the position, inclination angle, horizontal angle, and rotational angle of the tool. Such navigational packages can include, for example, accelerometers, magnetometers, and/or sensors. In some embodiments, a surface measurement system (not shown) can be used to determine the depth of the wireline tool 134. In some implementations, the wireline tool 134 may include one or more tools configured to capture measurements at one or more positions in the wellbore 116 such as gamma ray, density, neutron porosity, etc. Once the desired measurements are captured, the wireline tool 134 may return to the surface.

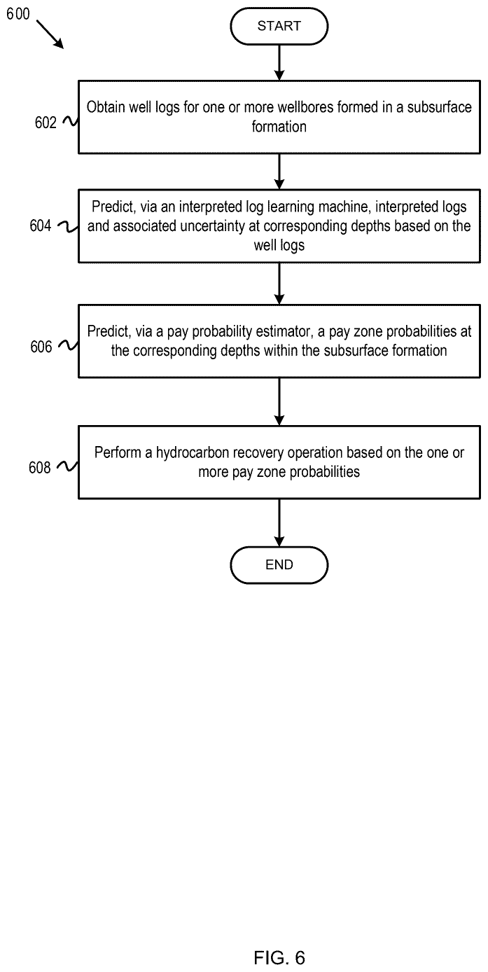

The drilling system 100 and/or the wireline system 101 includes a computer 190 that may be communicatively coupled to other parts of the drilling system 100 and/or wireline system 101. Additionally, the computer 190 may be communicatively coupled to other systems such as an intervention system (not pictured). The computer 190 may be local or remote to the drilling system 100 and/or the wireline system 101. A processor of the computer 190 may perform commands (as further described below) that position the downhole tool in the wellbore 116. In some implementations, the processor of the computer 190 may include instructions to direct and/or modify an operation in the wellbore 116 based on the pay zone probabilities within the subsurface formations 118 such as provide instructions to the bottom hole assembly to steer the drill bit through the subsurface formations 118, modify one or more drilling parameters such as weight on bit (WOB), drill bit rotations per minute (RPM), etc. An example of the computer 190 is depicted in FIG. 6, which is further described below.

Although FIGS. 1A and 1B depict specific borehole configurations, it should be understood by those skilled in the art that the present disclosure is equally well suited for use in wellbores having other orientations including vertical wellbores, horizontal wellbores, slanted wellbores, multilateral wellbores and the like. Also, even though FIGS. 1A and 1B depict an onshore operation, it should be understood by those skilled in the art that the present disclosure is equally well suited for use in offshore operations. Moreover, it should be understood by those skilled in the art that the present disclosure is not limited to the environments depicted in FIGS. 1A and 1B, and can also be used, for example, in other well operations such as non-conductive production tubing operations, jointed tubing operations, coiled tubing operations, combinations thereof, and the like.

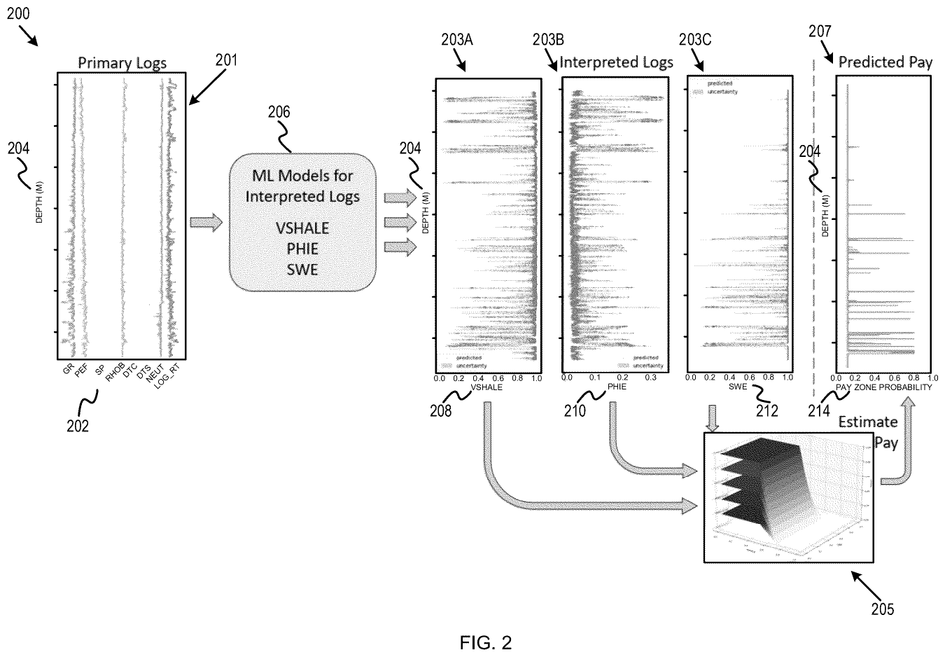

FIG. 2 is a diagram of a two stage approach for generating pay zone probabilities, according to some implementations. FIG. 2 is described in reference to the downhole tool 126, the wireline tool 134, and the computer 190 of FIGS. 1A-1B.

The first step comprises generating interpreted logs 203A-C, via an interpreted log learning machine 206, that may be useful for predicting pay such as volume of shale (VSHALE), effective porosity (PHIE) and effective water saturation (SWE), etc. The VSHALE may be the portion of the shale content in the rock. The PHIE is the portion of the total pore volume in a rock that contributes to fluid flow. The SWE is the fraction of the effective pore volume in a rock that is filled with water. A user may desire to predict the oil and/or gas pay zones in one or more wellbores formed in a subsurface formation such that a wellbore operations may be performed (such as an operation to recover the hydrocarbons from said pay zones). Primary well logs 201 (measurements 202 as a function of depth 204) such as gamma ray, density, neutron porosity, or any combination thereof may be obtained from each of the wellbores. The primary well logs 201 may be input into the interpreted log learning machine 206 to generate the interpreted logs 203A-C and associated uncertainties. The interpreted log learning machine 206 may be configured with machine learning models for each respective interpreted log output (one for each interpreted log; VSHALE, PHIE, and SWE). If existing (pre-trained) models are available, then those can be used directly, or fine-tuned (e.g. using transfer learning) with additional data. For each interpreted log 203A-C, the interpreted log learning machine 206 may be trained to provide estimates of the uncertainty on the prediction.

In some implementations, the interpreted log learning machine 206 may include more than one model (e.g., three models; one for the 10^{th} percentile, 50^{th} percentile, and 90^{th} percentile) trained using quantile regression to provide the interpreted logs 203A-C. If one of these three is the 50th percentile model then it may be used to predict the median value for the interpreted log, which may generally be approximately similar to the expected value. In addition, a (50−n)th percentile model and a (50+n)th percentile model may be used to provide measures of uncertainty for the interpreted logs 203A-C. In some implementations, n=34 (or n=47.5) may be used, indicating percentiles that correspond to one (or two) standard deviation(s) from the mean. Thus, if the models are accurate, there is a 68% (95%) chance of the true value lying within the percentile models corresponding to one (two) standard deviations.

n=40 is used herein for the example implementations described below, indicating the use of 10th and 90th percentile models. This may indicate that if the models are accurate, there may be an 80% chance of the true value lying within the values predicted by the 10th and 90th percentile models. The 10th and 90th percentile models may be used for convenience. Although n=40 and the 10^{th} and 90^{th} models are used, it should be understood by those skilled in the art that the present disclosure is equally well suited for any other suitable n value and associated percentile models. The interpreted logs 203A-C include three interpreted logs (VSHALE 208, PHIE 210 and SWE 212, respectively at corresponding depths 204 measured in meters (m)) along with their associated uncertainty (using 10th to 90th quantile regression models). In some instances, well log data may be noisy, and samples may typically have some data missing. Therefore, when selecting the type of model for the interpreted log learning machine 206 to predict interpreted logs 203A-C, it may be useful to choose a model that may be capable of handling null data as an input such as random forests, extreme gradient boosting, or a histogram-based gradient boosting regression tree, etc. Any other suitable machine learning model maybe used for the interpreted log learning machine 206.

Once the required interpreted logs 203A-C (and their respective uncertainties) are available, these can in turn be used to generate predicted pay 207 (the pay zone probability 214 as a function of depth 204) with the pay probability estimator 205. This may be done in various ways, via functions and/or machine learning models, as described below. Although the functions and/or machine learning models are used, it should be understood by those skilled in the art that the present disclosure is equally well suited for any other suitable function and/or machine learning model. The pay probability estimator 205 may generate the predicted pay 207 from the interpreted logs 203A-C using functions or machine learning models such as binary cutoffs and P50 log estimate, binary cutoffs incorporating log uncertainty, fuzzy cutoffs and P50 log estimate, fuzzy cutoffs incorporating log uncertainty, incorporating covariance, incorporating covariance and uncertainty, etc. The aforementioned examples are further described below.

Binary cutoffs may be applied to the interpreted log values, such as the P50 log estimate values, the mean log estimate values, etc. For example, if VSHALE is less than 0.6, PHIE is greater than 0.1 and SWE is less than 0.8 at a depth, then a pay result of 1 is predicted for that depth, but otherwise, a value of 0 is returned for predicted pay probability. This binary cutoff approach may be simple and easy to implement, but it may ignore any uncertainty associated with the interpreted logs 203A-C, and the hard cut-offs mean that there may be a sudden transition between pay and no-pay zones.

Binary cutoffs may incorporate interpreted log uncertainty. This approach may be similar to the above using binary cutoffs for pay, but the associated uncertainty generated by the interpreted log learning machine 206 may be included. For example, given VSHALE cut-off of 0.6, and VSHALE predictions of P10=0.4, P50=0.5, P90=0.6, then there may be a 90% confidence that the log has a value below the VSHALE cut-off, so pay (VSHALE)=0.9. The same may be applied to other interpreted logs such as PHIE and SWE.

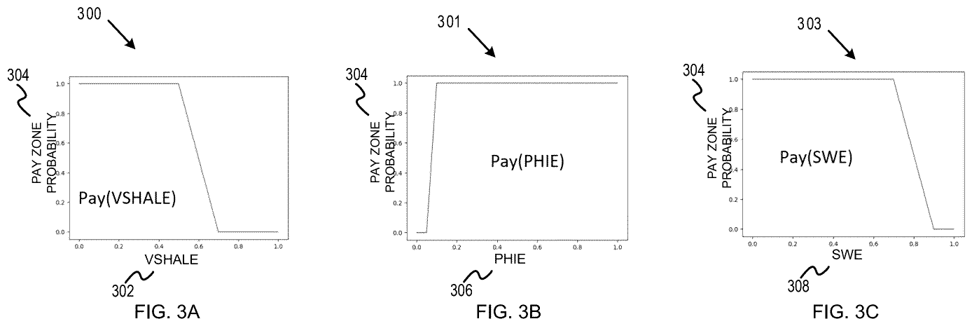

To reduce the occurrence of these sudden transitions, hard cut-offs may be replaced with “fuzzy” transition zones (i.e., fuzzy cutoffs). For example, instead of having a hard pay cutoff for VSHALE at 0.6, a more gradual transition for the range from 0.5 to 0.7 may be used. To help illustrate, FIGS. 3A-3C are charts of pay zone probabilities with fuzzy cutoffs, according to some implementations. FIG. 3A includes an x-axis 302 and a y-axis 304. The x-axis is the VSHALE, and the y-axis is the pay zone probability. A transition range may be set from 0.5-0.7 to represent the gradual transition zone. FIG. 3B includes an x-axis 306 and a y-axis 304. The x-axis is the PHIE, and the y-axis is the pay zone probability. A transition range may be set from 0.05-0.15 to represent the gradual transition zone. FIG. 3C includes an x-axis 302 and a y-axis 308. The x-axis is the SWE, and the y-axis is the pay zone probability. A transition range may be set from 0.7-0.9 to represent the gradual transition zone.

Note that the resultant pay zone probability may be taken as the product of its three constituent parts, namely Pay=Pay (VSHALE)×Pay (PHIE)×Pay (SWE), where pay is the pay probability. This means that the pay zone probability may be a real-valued number between 0.0 and 1.0 rather than just a binary value, making it more akin to a pay zone probability.

The pay probability estimation may be enhanced by factoring in the uncertainty associated with each of the interpreted logs. The benefit of this is that it may provide a pay calculation that better approximates the “spread” of the distributions associated with each interpreted log 203A-C. Using a factor, α, to weigh the distribution tails, a pay zone probability calculation may take the form of Equations 1-4 below:

$$Pay ( VSHALE ) = α Pay ( {VSHALE}_{P 10} ) + ( 1 - 2 α ) Pay ( {VSHALE}_{P 50} ) + α Pay ( {VSHALE}_{P 90} ) \qquad ( 1 )$$

$$Pay ( PHIE ) = α Pay ( {PHIE}_{P 10} ) + ( 1 - 2 α ) Pay ( {PHIE}_{P 50} ) + α Pay ( {PHIE}_{P 90} ) \qquad ( 2 )$$

$$Pay ( SWE ) = α Pay ( {SWE}_{P 10} ) + ( 1 - 2 α ) Pay ( {SWE}_{P 50} ) + α Pay ( {SWE}_{P 90} ) \qquad ( 3 )$$

$$Pay = Pay ( VSHALE ) \times Pay ( PHIE ) \times Pay ( SWE ) \qquad ( 4 )$$

Where a recommended value for α may be 0.15, although any other suitable value may be used.

Similar to the above, an extension may be where probability density functions may be defined for the interpreted log prediction e.g. P_{log}(VSHALE), and the (fuzzy) cut-off, P_{cutoff}(VSHALE). Then the pay likelihood may be determined by the integral of the product of the probability density functions as shown in Equation 5:

$$Pay ( VSHALE ) = {\int }_{0}^{1} ( {P}_{l o g} \cdot {P}_{cutoff} ) \partial {V}_{S H A L E} \qquad ( 5 )$$

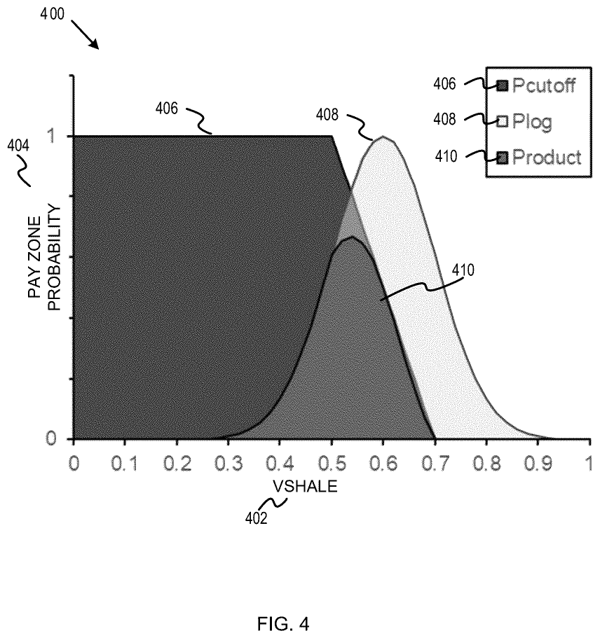

To help illustrate, FIG. 4 includes a chart of the probability density function approach for applying fuzzy cutoffs including uncertainty in the log estimate, according to some implementations. FIG. 4 includes a chart 400 with an x-axis 402 and a y-axis 404. The x-axis 402 is the VSHALE and the y-axis 404 is the pay zone probability. The pay zone probability for this approach is calculated as the area under the product 410 of P_{log} 408 and P_{cutoff} 406. Thus, the probability density function approach may provide a distribution of pay zone probabilities for each interpreted log rather than samples of said distribution (i.e., 10^{th}, 50^{th}, and 90^{th} percentile values).

Thus far, the pay function has been separable, with the contributions of each of the three interpreted logs 203A-C calculated separately and then multiplied together. However, it may be useful to consider the possibility of covariance between the interpreted logs 203A-C. For example, the (fuzzy) threshold for SWE may vary somewhat when VSHALE is 0.4 versus when VSHALE is 0.7. To allow for more realistic pay estimates, covariance may be incorporated into the pay probability estimator 205 for estimating pay.

One could specify a 3×3 covariance matrix directly, but this may not be intuitive to a user. Therefore, to be more intuitive for the user, an approach for this method may be to use a pre-trained model (with a default covariance matrix), or for sample pay values for different combinations of the three variables to be provided (e.g., interpreted log samples and corresponding pay zone probability samples). Initially, this may be done on a sparse grid such as the samples in Table 1 below:

TABLE 1

| | | | | | | | | | | | | | | | | |
|---|---|---|---|---|---|---|---|---|---|---|---|---|---|---|---|---|
| VSHALE | 0.0 | 0.0 | 0.0 | 0.0 | 0.0 | 0.0 | 0.0 | 0.0 | 0.0 | 0.0 | 0.0 | . . . | 1.0 | 1.0 | 1.0 | 1.0 |
| PHIE | 0.0 | 0.0 | 0.0 | 0.0 | 0.0 | 0.25 | 0.25 | 0.25 | 0.25 | 0.25 | 0.5 | . . . | 1.0 | 1.0 | 1.0 | 1.0 |
| SWE | 0.0 | 0.25 | 0.5 | 0.75 | 1.0 | 0.0 | 0.25 | 0.5 | 0.75 | 1.0 | 0.0 | . . . | 0.25 | 0.5 | 0.75 | 1.0 |
| Pay | | | | | | | | | | | | . . . | | | | |

Where a user may provide the pay zone probabilities for each of the interpreted log samples in each column. For example, the pay zone probability samples provided may include values ranging from 0 to 1, where 0 may be considered no pay and 1 may be considered pay. In some implementations, a denser set of sample points in the transition zones (e.g. where PHIE˜0.1) may be provided. Once a sufficient number of points have been specified, the interpreted log samples and corresponding pay zone probability samples can be used to either define a pay zone function (using interpolation between the given sample points), and/or train a pay zone learning machine (such as a neural network) that can predict the pay probability given interpreted log as input. This may result in a function similar to that shown in Equation 5. Note that this does not consider uncertainty associated with each interpreted logs, but a weighted sum approach similar to that described above may be used if required.

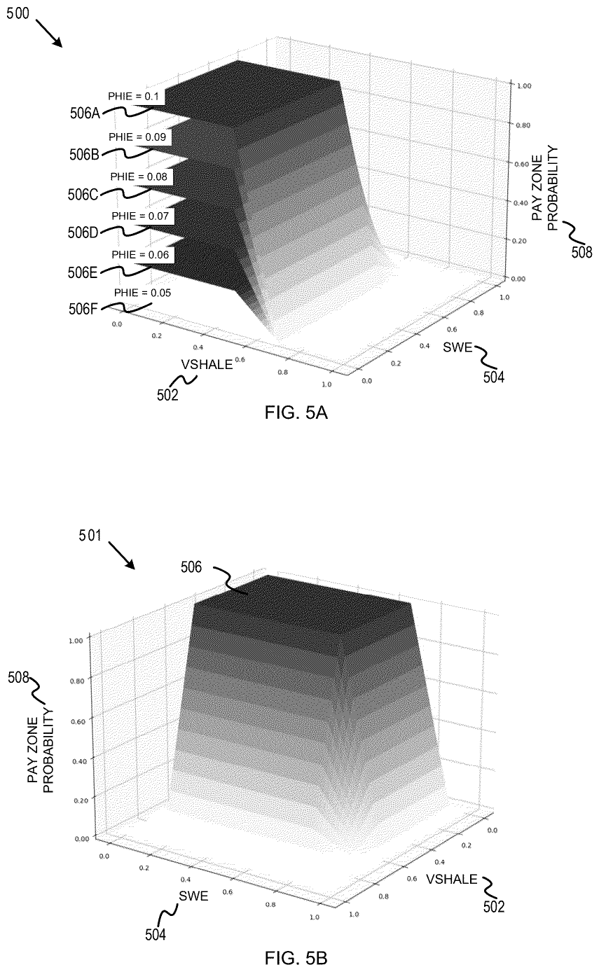

To help illustrate, FIGS. 5A-5B are charts depicting a pay probability estimator that takes interpreted logs as input, according to some implementations. In particular, FIG. 5A includes a chart 500 of pay zone probabilities 508 generated by a pay probability estimator with inputs of VSHALE 502, SWE 504, and PHIE 506A-F. The pay probability estimator may be a function (such as the binary cutoff, fuzzy cutoffs, etc. with or without uncertainty incorporated), a machine learning model that may be pretrained or trained on sample data such as depicted in Table 1, etc. Similarly, FIG. 5B includes a chart 501 of pay zone probabilities 508 generated by a pay probability estimator with inputs of VSHALE 502, SWE 504, and PHIE 506.

In some implementations, an extension of the approach described above may be to utilize a machine learning model that may incorporate interpreted log uncertainty, but may take e.g., 9 inputs rather than 3. For example, inputs may include VSHALE_P10 (10^{th} percentile), VSHALE_P50 (50^{th} percentile), VSHALE_P90 (90^{th} percentile), PHIE_P10 (10^{th} percentile), PHIE_P50 (50^{th} percentile), PHIE_P90 (90^{th} percentile), SWE_P10 (10^{th} percentile), SWE_P50 (50^{th} percentile), and SWE_P90 (90^{th} percentile). In some implementations, the user may be provided with two default models (one for gas pay and the other for oil pay) with the option of re-training them if required.

Accordingly, the above options may provide a range of methods for estimating pay zone probabilities from the interpreted logs 203A-C (VSHALE, PHIE and SWE). One or more of these methods may be chosen for a pay probability estimator 205 in order to obtain a pay zone probabilities that may be derived from the primary well logs 201 via the set of interpreted logs 203A-C.

### Example Operations

FIG. 6 is a flowchart of example operations for predicting pay zone probabilities at corresponding depths within a subsurface formation, according to some implementations. FIG. 6 depicts a flowchart 600 of a two-stage operation to determine pay zone probabilities. The operations of flowchart 600 are described in reference to the computer 190 of FIG. 1. Additionally, interpreted log learning machine and pay probability estimator in the operations of the flowchart 600 are described in reference to the interpreted log learning machine 206 and the pay probability estimator 205 of FIG. 2. Operations of the flowchart 600 begin at block 602.

At block 602, the processor of the computer 190 may obtain well logs for one or more wellbores formed in a subsurface formation.

At block 604, the processor of the computer 190 may predict, via an interpreted log learning machine, interpreted logs and associated uncertainty at corresponding depths based on the well logs.

At block 606, the processor of the computer 190 may predict, via a pay probability estimator, a pay zone probabilities at the corresponding depths within the subsurface formation.

At block 608, the processor of the computer 190 may perform a wellbore operation based on the one or more pay zone probabilities.

While the aspects of the disclosure are described with reference to various implementations and exploitations, it will be understood that these aspects are illustrative and that the scope of the claims is not limited to them. In general, predicting pay zone probabilities as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

### Example Computer

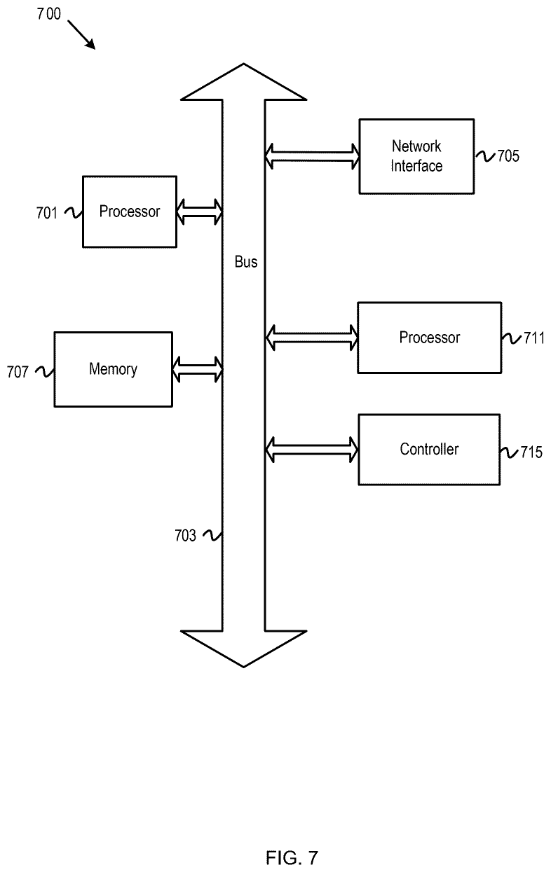

FIG. 7 is a block diagram depicting an example computer, according to some implementations. FIG. 7 depicts a computer 700 for predicting pay zone probabilities of a subsurface formation. The computer 700 includes a processor 701 (possibly including multiple processors, multiple cores, multiple nodes, and/or implementing multi-threading, etc.). The computer 700 includes memory 707. The memory 707 may be system memory or any one or more of the above already described possible realizations of machine-readable media. The computer 700 also includes a bus 703 and a network interface 705. The computer 700 can communicate via transmissions to and/or from remote devices via the network interface 705 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

The computer 700 also includes a processor 711 and a controller 715 which may perform the operations described herein. For example, the processor 711 may determine interpreted logs, via an interpreted log learning machine, based on primary well logs. The processor 711 may also generate pay zone probabilities, via a pay probability estimator, with the interpreted logs as input. The controller 715 may perform an operation based on the pay zone probabilities, such as modifying completion operations to optimize hydrocarbon recovery. The processor 711 and the controller 715 can be in communication. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Example Implementations

Implementation #1: A method comprising: obtaining well logs for at least one measurable subsurface formation attribute of a subsurface formation into which a wellbore is formed; and performing a multi-stage operation to predict a pay probability for a zone in the subsurface formation that defines a likelihood that the zone includes hydrocarbons that are commercially viable for recovery, wherein performing the multi-stage operation comprises, predicting, via at least one interpreted log machine-learning model using the well logs as inputs, interpreted logs of at least one interpreted subsurface attribute at corresponding depths of the wellbore; and predicting, via a pay zone probability machine-learning model using the interpreted logs as inputs, the pay probability for the zone.
Implementation #2: The method of Implementation #1, wherein performing the multi-stage operation comprises determining an uncertainty for at least one of the interpreted logs.
Implementation #3: The method of Implementation #2, wherein predicting the pay probability comprises predicting, via the pay zone probability machine-learning model using the interpreted logs and the uncertainty for the at least one of the interpreted logs as inputs, the pay probability for the zone.
Implementation #4: The method of any one of Implementations #1-3, wherein the at least one measurable subsurface formation attribute includes at least one of gamma ray, density, or neutron porosity.
Implementation #5: The method of Implementation #4, wherein the at least one interpreted subsurface attribute includes at least one of volume of shale, effective porosity, or effective water saturation.
Implementation #6: The method of any one of Implementations #1-5, wherein the zone having hydrocarbons that are commercially viable for recovery comprises a zone having hydrocarbons having a production value that exceeds a production cost by a viable threshold.
Implementation #7: The method of any one of Implementations #1-6, wherein the at least one interpreted log machine-learning model comprises a first percentile machine-learning model, a second percentile machine-learning model, and a third percentile machine-learning model.
Implementation #8: The method of Implementation #7, wherein the second percentile machine-learning model comprises a 50th percentile machine-learning model.
Implementation #9: The method of any one of Implementations #1-8, wherein the pay zone probability machine-learning model comprises at least one of a binary cutoff machine-learning model or a fuzzy cutoff machine-learning model.
Implementation #10: The method of any one of Implementations #1-9, wherein a wellbore operation is modified based on the pay probability for the zone.
Implementation #11: A non-transitory, computer-readable medium having instructions stored thereon that are executable by a processor, the instructions comprising: instructions to obtain well logs for at least one measurable subsurface formation attribute of a subsurface formation into which a wellbore is formed; and instructions to perform a multi-stage operation to predict a pay probability for a zone in the subsurface formation that defines a likelihood that the zone includes hydrocarbons that are commercially viable for recovery, wherein the instructions to perform the multi-stage operation comprises, instructions to predict, via at least one interpreted log machine-learning model using the well logs as inputs, interpreted logs of at least one interpreted subsurface attribute at corresponding depths of the wellbore; and instructions to predict, via a pay zone probability machine-learning model using the interpreted logs as inputs, the pay probability for the zone.
Implementation #12: The non-transitory, computer-readable medium of Implementation #11, wherein instructions to perform the multi-stage operation comprise instructions to determine an uncertainty for at least one of the interpreted logs and wherein instructions to predict the pay probability comprise instructions to predict, via the pay zone probability machine-learning model using the interpreted logs and the uncertainty for the at least one of the interpreted logs as inputs, the pay probability for the zone.
Implementation #13: The non-transitory, computer-readable medium of any one of Implementations #11-12, wherein the at least one measurable subsurface formation attribute includes at least one of gamma ray, density, or neutron porosity, and wherein the at least one interpreted subsurface attribute includes at least one of volume of shale, effective porosity, or effective water saturation.
Implementation #14: The non-transitory, computer-readable medium of any one of Implementations #11-13, wherein the at least one interpreted log machine-learning model comprises a first percentile machine-learning model, a second percentile machine-learning model, and a third percentile machine-learning model.
Implementation #15: The non-transitory, computer-readable medium of any one of Implementations #11-14, wherein the pay zone probability machine-learning model comprises at least one of a binary cutoff machine-learning model or a fuzzy cutoff machine-learning model.
Implementation #16: The non-transitory, computer-readable medium of any one of Implementations #11-15, wherein a wellbore operation is modified based on the pay probability for the zone.
Implementation #17: A system comprising: a processor; and a computer-readable medium having instructions stored thereon that are executable by the processor, the instructions including, instructions to obtain well logs for at least one measurable subsurface formation attribute of a subsurface formation into which a wellbore is formed; and instructions to perform a multi-stage operation to predict a pay probability for a zone in the subsurface formation that defines a likelihood that the zone includes hydrocarbons that are commercially viable for recovery, wherein the instructions to perform the multi-stage operation comprises, instructions to predict, via at least one interpreted log machine-learning model using the well logs as inputs, interpreted logs of at least one interpreted subsurface attribute at corresponding depths of the wellbore; and instructions to predict, via a pay zone probability machine-learning model using the interpreted logs as inputs, the pay probability for the zone.
Implementation #18: The system of Implementation #17, wherein instructions to perform the multi-stage operation comprise instructions to determine an uncertainty for at least one of the interpreted logs and wherein instructions to predict the pay probability comprise instructions to predict, via the pay zone probability machine-learning model using the interpreted logs and the uncertainty for the at least one of the interpreted logs as inputs, the pay probability for the zone.
Implementation #19: The system of any one of Implementations #17-18, wherein the at least one measurable subsurface formation attribute includes at least one of gamma ray, density, or neutron porosity, and wherein the at least one interpreted subsurface attribute includes at least one of volume of shale, effective porosity, or effective water saturation.
Implementation #20: The system of any one of Implementations #17-20, wherein a wellbore operation is modified based on the pay probability for the zone.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A method comprising:
obtaining well logs for at least one measurable subsurface formation attribute of a subsurface formation into which a wellbore is formed; and
performing a multi-stage operation to predict a pay probability for a zone in the subsurface formation that defines a likelihood that the zone includes hydrocarbons that are commercially viable for recovery, wherein performing the multi-stage operation comprises,
predicting, via at least one interpreted log machine-learning model using the well logs as inputs, interpreted logs of at least one interpreted subsurface attribute at corresponding depths of the wellbore; and
predicting, via a pay zone probability machine-learning model using the interpreted logs as inputs, the pay probability for the zone.

2. The method of claim 1, wherein performing the multi-stage operation comprises determining an uncertainty for at least one of the interpreted logs.

3. The method of claim 2, wherein predicting the pay probability comprises predicting, via the pay zone probability machine-learning model using the interpreted logs and the uncertainty for the at least one of the interpreted logs as inputs, the pay probability for the zone.

4. The method of claim 1, wherein the at least one measurable subsurface formation attribute includes at least one of gamma ray, density, or neutron porosity.

5. The method of claim 4, wherein the at least one interpreted subsurface attribute includes at least one of volume of shale, effective porosity, or effective water saturation.

6. The method of claim 1, wherein the zone having hydrocarbons that are commercially viable for recovery comprises a zone having hydrocarbons having a production value that exceeds a production cost by a viable threshold.

7. The method of claim 1, wherein the at least one interpreted log machine-learning model comprises a first percentile machine-learning model, a second percentile machine-learning model, and a third percentile machine-learning model.

8. The method of claim 7, wherein the second percentile machine-learning model comprises a 50th percentile machine-learning model.

9. The method of claim 1, wherein the pay zone probability machine-learning model comprises at least one of a binary cutoff machine-learning model or a fuzzy cutoff machine-learning model.

10. The method of claim 1, wherein a wellbore operation is modified based on the pay probability for the zone.

11. A non-transitory, computer-readable medium having instructions stored thereon that are executable by a processor, the instructions comprising:
instructions to obtain well logs for at least one measurable subsurface formation attribute of a subsurface formation into which a wellbore is formed; and
instructions to perform a multi-stage operation to predict a pay probability for a zone in the subsurface formation that defines a likelihood that the zone includes hydrocarbons that are commercially viable for recovery, wherein the instructions to perform the multi-stage operation comprises,
instructions to predict, via at least one interpreted log machine-learning model using the well logs as inputs, interpreted logs of at least one interpreted subsurface attribute at corresponding depths of the wellbore; and
instructions to predict, via a pay zone probability machine-learning model using the interpreted logs as inputs, the pay probability for the zone.

12. The non-transitory, computer-readable medium of claim 11,
wherein instructions to perform the multi-stage operation comprise instructions to determine an uncertainty for at least one of the interpreted logs and
wherein instructions to predict the pay probability comprise instructions to predict, via the pay zone probability machine-learning model using the interpreted logs and the uncertainty for the at least one of the interpreted logs as inputs, the pay probability for the zone.

13. The non-transitory, computer-readable medium of claim 11, wherein the at least one measurable subsurface formation attribute includes at least one of gamma ray, density, or neutron porosity, and wherein the at least one interpreted subsurface attribute includes at least one of volume of shale, effective porosity, or effective water saturation.

14. The non-transitory, computer-readable medium of claim 11, wherein the at least one interpreted log machine-learning model comprises a first percentile machine-learning model, a second percentile machine-learning model, and a third percentile machine-learning model.

15. The non-transitory, computer-readable medium of claim 11, wherein the pay zone probability machine-learning model comprises at least one of a binary cutoff machine-learning model or a fuzzy cutoff machine-learning model.

16. The non-transitory, computer-readable medium of claim 11, wherein a wellbore operation is modified based on the pay probability for the zone.

17. A system comprising:
a processor; and
a computer-readable medium having instructions stored thereon that are executable by the processor, the instructions including,
instructions to obtain well logs for at least one measurable subsurface formation attribute of a subsurface formation into which a wellbore is formed; and
instructions to perform a multi-stage operation to predict a pay probability for a zone in the subsurface formation that defines a likelihood that the zone includes hydrocarbons that are commercially viable for recovery, wherein the instructions to perform the multi-stage operation comprises,
instructions to predict, via at least one interpreted log machine-learning model using the well logs as inputs, interpreted logs of at least one interpreted subsurface attribute at corresponding depths of the wellbore; and
instructions to predict, via a pay zone probability machine-learning model using the interpreted logs as inputs, the pay probability for the zone.

18. The system of claim 17,
wherein instructions to perform the multi-stage operation comprise instructions to determine an uncertainty for at least one of the interpreted logs and
wherein instructions to predict the pay probability comprise instructions to predict, via the pay zone probability machine-learning model using the interpreted logs and the uncertainty for the at least one of the interpreted logs as inputs, the pay probability for the zone.

19. The system of claim 17, wherein the at least one measurable subsurface formation attribute includes at least one of gamma ray, density, or neutron porosity, and wherein the at least one interpreted subsurface attribute includes at least one of volume of shale, effective porosity, or effective water saturation.

20. The system of claim 17, wherein a wellbore operation is modified based on the pay probability for the zone.
